(19) United States
(12) Patent Application Publication
(10) Pub. No.: US 2021/0318182 A1
(43) Pub. Date: Oct. 14, 2021

(54) DISTRIBUTED FIBER OPTIC SENSING OF TEMPERATURE USING A POLARIZATION SCRAMBLER

(71) Applicant: NEC Laboratories America, Inc., Princeton, NJ (US)

(72) Inventors: Yaowen LI, Princeton, NJ (US); Yue-Kai HUANG, Princeton, NJ (US); Ting WANG, West Windsor, NJ (US)

(73) Assignee: NEC LABORATORIES AMERICA, INC, Princeton, NJ (US)

(21) Appl. No.: 17/227,314

(22) Filed: Apr. 10, 2021

Related U.S. Application Data
(60) Provisional application No. 63/008,886, filed on Apr. 13, 2020.

(51) Int. Cl. G01K 11/324; H04B 10/2569

(52) U.S. Cl. CPC G01K 11/324; H04B 10/2569

(57) ABSTRACT

Aspects of the present disclosure describe distributed fiber optic sensing (DFOS) systems, methods, and structures that advantageously achieve single mode fiber distributed temperature sensing (DTS) with improved noise characteristics by employing a polarization scrambler in its optical chain.

### CROSS REFERENCE

This disclosure claims the benefit of U.S. Provisional Patent Application Ser. No. 63/008,886 filed 13 Apr. 2020 the entire contents of which is incorporated by reference as if set forth at length herein.

### TECHNICAL FIELD

This disclosure relates generally to distributed fiber optic sensing (DFOS) systems, methods, and structures that provide distributed temperature sensing (DTS). More particularly, it describes an improved DFOS-DTS that exhibits improved noise characteristics.

### BACKGROUND

Distributed temperature sensing (DTS) systems utilizing optical fiber cable as a linear sensing medium has found widespread applicability in numerous industrial segments in including oil and gas production, power cable and transmission line monitoring, fire detection, and temperature monitoring in plant and process engineering. While a majority of DTS systems employ multi-mode optical fiber as sensing medium, there nevertheless are DTS systems that utilize single mode optical fiber as the sensing medium.

A noted problem with such single mode DTS systems, however, is that they suffer from temperature noise originating from their light source(s)

### SUMMARY

An advance in the art is made according to aspects of the present disclosure directed to Raman-based systems, methods, and structures for distributed temperature sensing using single mode optical fiber as sensing medium.

In sharp contrast to the prior art—systems, methods, and structures according to aspects of the present disclosure achieve single mode fiber distributed temperature sensing (DTS) with improved noise characteristics by employing a polarization scrambler in its optical chain.

Viewed from a particular aspect, the present disclosure is directed to a distributed temperature sensing (DTS) system comprising: a length of single-mode optical fiber; and an optical interrogator unit that generates optical pulses, introduces them into the optical fiber, receives backscattered signals from the optical fiber, and determines one or more temperatures at points along the optical fiber from the backscattered signals; the DTS system CHARACTERIZED BY: a polarization scrambler that scrambles the polarization of the generated optical pulses prior to their introduction into the optical fiber.

### BRIEF DESCRIPTION OF THE DRAWING

A more complete understanding of the present disclosure may be realized by reference to the accompanying drawing in which:

FIG. 1(A) is a schematic diagram of an illustrative prior art DTS configuration generally known in the art;

FIG. 1(B) is an illustrative DTS plot of Backscattered Intensity vs. Wavelength for the configuration of FIG. 1(A);

FIG. 2 is a plot of Temperature (° C.) vs. Fiber Length (km) resulting from single mode DTS having a directly modulated DFB source;

FIG. 3 is a schematic diagram of an illustrative improved DTS configuration exhibiting improved noise characteristics according to aspects of the present disclosure;

FIG. 4 is a plot of Temperature (° C.) vs. Fiber Length (km) resulting from the improved system of FIG. 3 according to aspects of the present disclosure; and

FIG. 5 is a plot of Temperature (° C.) vs. Fiber Length (km) resulting from the improved system of FIG. 3 for both when polarization scrambler is on and when polarization scrambler is off, according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we begin by noting that distributed fiber optic sensing (DFOS) is an important and widely used technology to detect environmental conditions (such as temperature, vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes an interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The signal carries information the interrogator—and subsequent processing—uses to detect—for example—temperature conditions experienced at various points along the fiber.

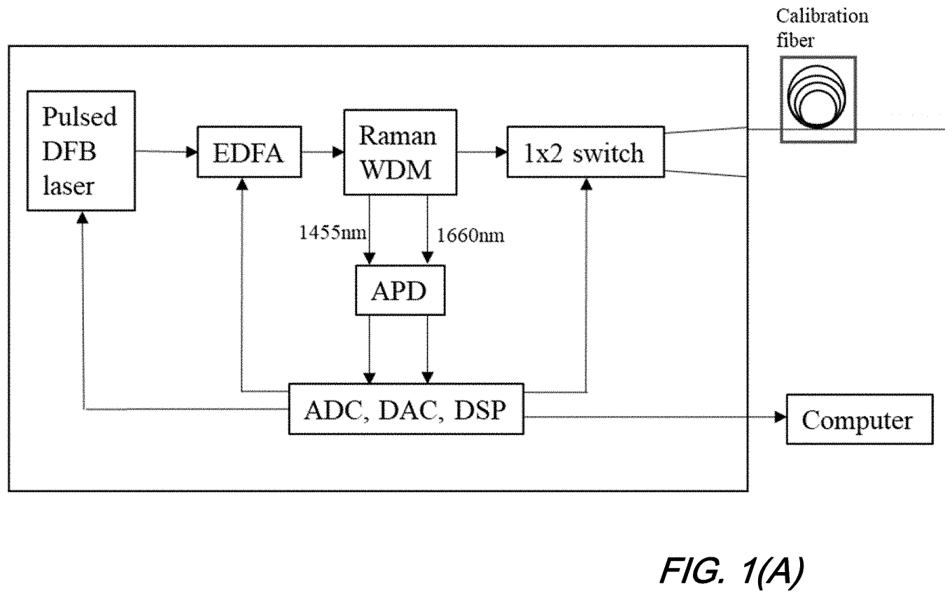

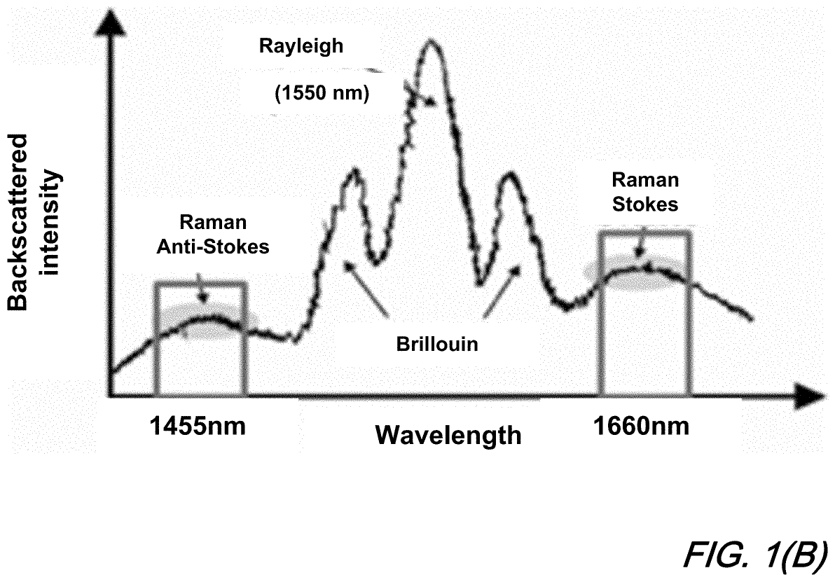

FIG. 1(A) shows a schematic diagram illustrating a prior art single mode fiber, single ended DTS configuration that is subject to the type(s) of noise problems noted above. Also shown in FIG. 1(B) is an illustrative plot of Backscattered light Intensity vs. Wavelength.

With simultaneous reference to those figures, it may be observed that a contemporary/common single mode fiber DTS configuration will typically include a directly modulated distributed feedback laser (DFB laser) the output of which is directed through an erbium-doped fiber amplifier (EDFA) to a Raman wavelength division multiplexer (WDM). The light through the WDM is then directed to a 1×2 optical switch and subsequently applied to the single mode fiber.

Operationally, and as will be readily appreciated by those skilled in the art, the DFB laser (1550 nm or other wavelengths) is highly coherent and polarized and generates optical pulses having pulse width(s) of several nanoseconds to tens of nanoseconds. The EDFA amplifies the optical pulses which are then directed through the Raman WDM, the 1×2 switch and launched into the single mode optical fiber. In a typical configuration such as that shown, a first part of the fiber is used for calibration, and subsequent part(s) of the fiber provide temperature sensing function(s).

A spectrum of backscattered light with the launching light at 1550 nm is shown graphically in FIG. 1(B), and the backscattered light is filtered by the Raman WDM into two bands, namely 1455 nm and 1660 nm, and subsequently directs those bands to two high gain avalanche photodetector (APD) detectors. Output signals from the APDs are directed to a data acquisition system and computer for processing, evaluation, and temperature determination(s).

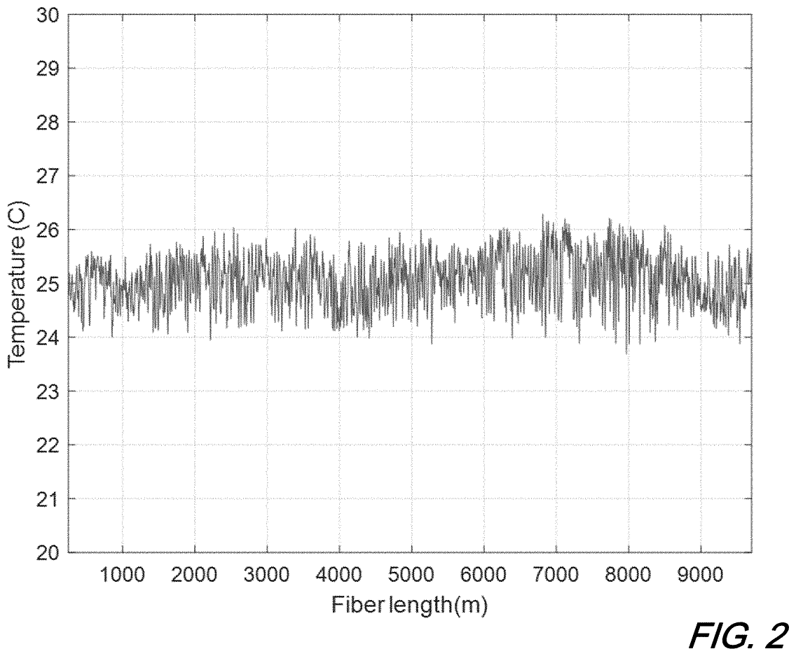

FIG. 2 is a plot of Temperature (C) vs. Fiber Length (km) resulting from single mode DTS having a directly modulated DFB source such as that shown in FIG. 1(A) including ˜10 km SMF28 optical fiber(s), and were conducted at room temperature (˜25 C). As we can determine, temperature noise for the whole fiber length is around +/−1 C.

We have now discovered—according to aspects of the present disclosure—that by adding a polarization scrambler into the DTS system and adjusting a proper scrambling rate that the temperature noise(s) noted above in the art were surprisingly and substantially improved.

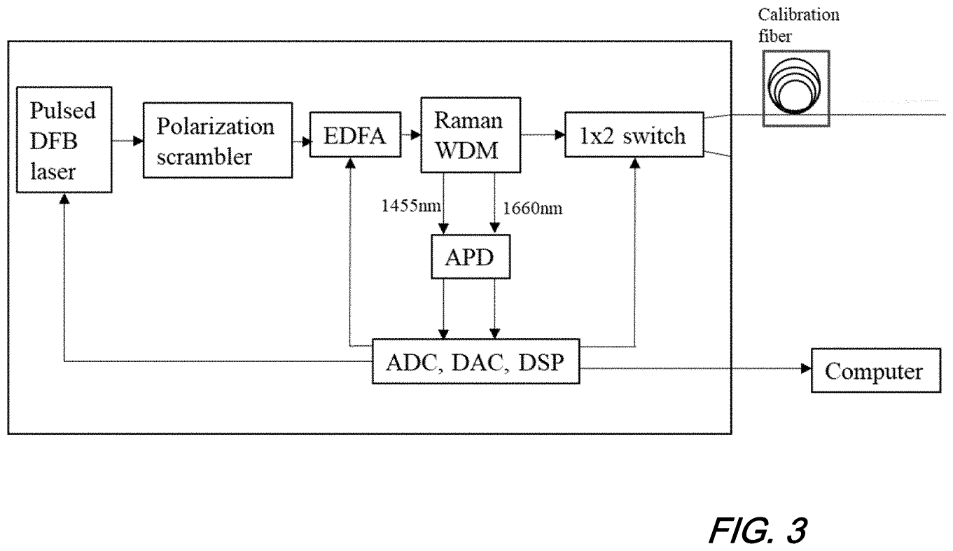

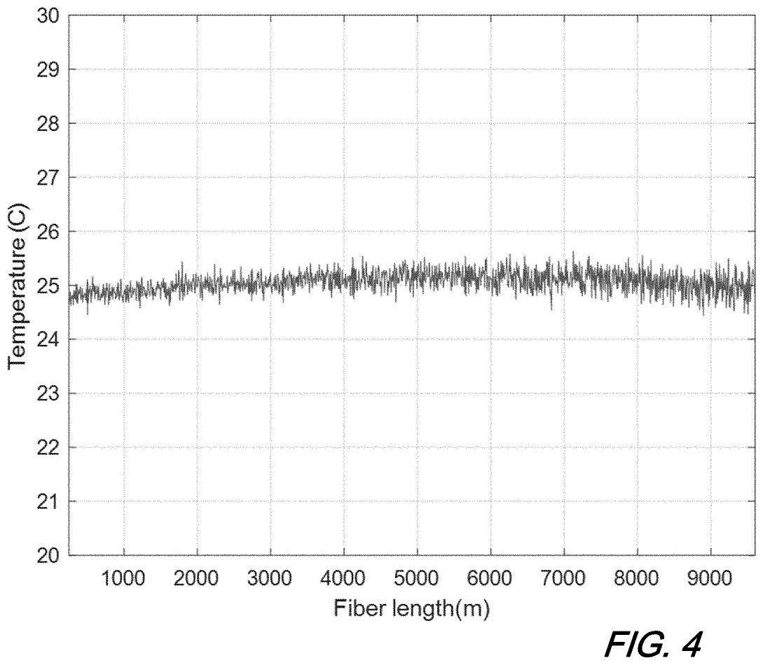

FIG. 3 is a schematic diagram of an illustrative improved DTS configuration exhibiting improved noise characteristics according to aspects of the present disclosure, and FIG. 4 is a plot of Temperature (C) vs. Fiber Length (km) resulting from the improved system of FIG. 3 according to aspects of the present disclosure.

From the plot, one can readily observe the improved noise characteristics for systems, methods, and structures according to aspects of the present disclosure employing a polarization scrambler in the optical chain as compared to the prior art shown in FIG. 2.

It may be determined that temperature noise(s) are reduced from +/−1 C in the prior art (FIG. 2) to ˜+/−0.3 C in systems, methods, and structures according to the present disclosure (FIG. 4). The pulse rate of DTS source was at 7 KHz, and the polarization scrambling rate was set at 3 KHz. Similar results were obtained for scrambling rates from 3 KHz to 8 KHz. The range of employed scrambling rate to achieve similar positive results might be even larger.

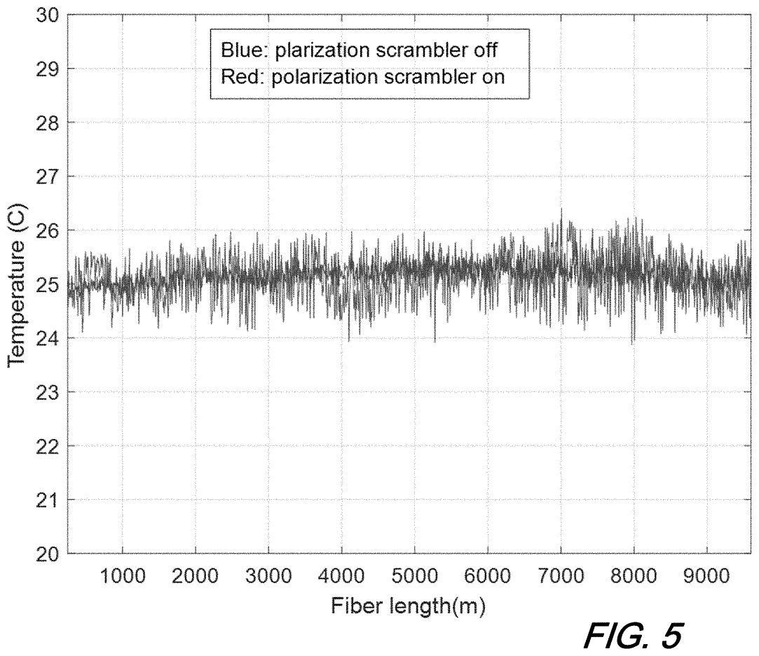

FIG. 5 is a plot of Temperature (C) vs. Fiber Length (km) resulting from the improved system of FIG. 3 for both when polarization scrambler is on and when polarization scrambler is off, according to aspects of the present disclosure. As may be observed from the plot, the temperature noise improvement is readily apparent.

At this point, while we have presented this disclosure using some specific examples, those skilled in the art will recognize that our teachings are not so limited. For example, placement of the polarization scrambler in the DTS configuration variable. More particularly, similar positive results were obtained by placing the polarization scrambler before and after the 1×2 switch as shown in FIG. 3. In certain situations, it may be advantageous to place the polarization scrambler after the Raman WDM in some configurations since the device will scrambler the polarization of all the light—both transmitted and received. One drawback to this configuration may be that the receiving light will experience extra losses compared to the configuration of FIG. 3. Accordingly, this disclosure should only be limited by the scope of the claims attached hereto.

1. A distributed temperature sensing (DTS) system comprising:
a length of single-mode optical fiber; and
an optical interrogator unit that generates optical pulses, introduces them into the optical fiber, receives backscattered signals from the optical fiber, and determines one or more temperatures at points along the optical fiber from the backscattered signals;
the DTS system CHARACTERIZED BY:
a polarization scrambler that scrambles the polarization of the generated optical pulses prior to their introduction into the optical fiber.

2. The system of claim 1 FURTHER CHARACTERIZED BY:
a Raman wavelength-division-multiplexing filter (WDM filter) interposed in an optical path of the generated optical pulses between the light source and the optical fiber.

3. The system of claim 2 FURTHER CHARACTERIZED BY:
an erbium-doped fiber amplifier (EDFA) interposed in the optical path of the generated optical pulses between the WDM filter and the optical fiber.

4. The system of claim 3 FURTHER CHARACTERIZED BY:
an optical switch interposed in the optical path of the generated optical pulses between the Raman WDM and the optical fiber.
